(19) United States
(12) Patent Application Publication
(10) Pub. No.: US 2016/0055668 A1
(43) Pub. Date: Feb. 25, 2016

(54) METHOD FOR GENERATING A HISTORICAL-GEOGRAPHIC REPRESENTATION FROM A GEOGRAPHIC MAP

(71) Applicant: EM PUBLISHERS S.r.l, Milano (IT)

(72) Inventors: Danco Singer, Milano (IT); Mauro Mattioli, Milano (IT)

(21) Appl. No.: 14/779,727

(22) PCT Filed: Mar. 25, 2013
(86) PCT No.: PCT/IT2013/000087

§ 371 Date: Sep. 24, 2015

(51) Int. Cl. G06T 17/05

(52) U.S. Cl. CPC G06T 17/05

(57) ABSTRACT

A method of generating a historical-geographic representation from a geographic map, which comprises:—displaying a geographic map on a monitor, by means of a computer, as a vector image comprising a primary terrestrial area;—dividing, by using the computer, the primary terrestrial area into a plurality of adjacent, non-overlapping elemental areas, which together cover the entire primary area;—associating each elemental area with at least one numerical time interval included in a macro-historical period, the numerical interval being associated with a historical layer, indicative of a geopolitical entity;—receiving time data indicative of a historical time included in said macro-historical period;—selecting a numerical time interval for each elemental area, said interval including the time data so received, and extracting the historical layer associated with the selected numerical time interval;—displaying the primary terrestrial area by associating a color to each historical layer, such that different historical layers are associated with different colors and elemental areas associated with the same historical layer are graphically represented with the same color.

The present invention concerns a method of generating a historical-geographic representation from a geographic map.

Particularly, the present disclosure relates to a method for georeferencing and displaying geographical information from a digital image of a geographic map.

In the field of historical map analysis, application programs are known, which allow digital graphical representation of a geographical area in a given historical period, e.g. rendered by means of a computer monitor. In these applications, a user that interacts with the application program using an input device (e.g. a mouse, a touchscreen, etc.) may select a historical period from a list of historical periods and display a series of images that “picture” the political configuration of the relevant geographical area at each historical instant that has been selected.

Nevertheless, such representations are static, because state boundary changes, as well as the history of the main political events in a particular geographical area may be deduced by comparison of the images associated with two different historical periods.

The Applicant has observed that, especially in case of a long time axis from an initial historical time to a final historical time, e.g. Europe from pre-Roman times to the end of the Second World War, the visualization of a series of images associated with different historical times is long, each representing the geopolitical map of the geographical area of interest at a given time, may not allow historical analysis of particular geographical regions within the geographical area of interest.

The Applicant has understood that it would be particularly advantageous to select and display the political evolution with time in a terrestrial area, and possibly of any geographical region defined within said area of interest. In particular, it would be particularly advantageous to display the inclusion of a geographical area of interest or of a region thereof in one or more States at different historical times, or to display how historical-political boundaries of the area have changed with time. This would allow a dynamic display of a geopolitical map with time.

In one aspect, the present invention relates to a method of generating a historical-geographical representation from a geographic map file, comprising:
graphically representing a geographic map file on a screen, by means of a computer, as an image in vector format comprising a primary terrestrial area;
dividing, by using the computer, the primary terrestrial area into a plurality of adjacent, non-overlapping elemental areas, the joining together of the elemental areas covering the primary area;
associating, by means of the computer, each elemental area with at least one numerical time interval, indicative of a historical interval included in a macro-numerical interval indicative of a macro-historical period, the numerical interval being associated with a historical layer, indicative of a geopolitical entity;
receiving, by using the computer, time data indicative of a historical time included in said macro-historical period;
selecting, by means of the computer, a numerical time interval for each elemental area, said interval including the received time data, and extracting the historical layer associated with the selected numerical time interval;
graphically rendering, by means of the computer, the primary terrestrial area on the screen, by associating a given numerical light intensity value with each historical layer, such that different historical layers are associated with different light intensity numerical values and the elemental areas associated with the same historical layer are graphically represented with the same light intensity value.

Preferably, the historical layer is implemented with an ID code, e.g. an alphanumeric code.

In the preferred embodiments, the primary terrestrial area has an outer edge consisting of a closed outline, and dividing the primary terrestrial area into a plurality of elemental areas comprises:
(i) receiving, in a computer, graphical input data, identifying a polyline composed of a plurality of successive segments, and having first and second ends;
(ii) generating a digital representation of the graphical input data;
(iii) determining the topology of the polyline in the primary image;
(iv) checking whether the topology of the polyline fulfills a plurality of topological conditions, and
(v) if the check is positive, storing the polyline.

Preferably, the step (v) further comprises: if the check is negative, rejecting the polyline and repeating the steps from (i) to (iv).

Each segment of the plurality of segments that form the polyline has first and second vertices. Preferably, the step (iv) comprises checking whether the following topological conditions are fulfilled:
a) both ends of the polyline coincide with two respective points of the outer edge of the primary geographical area;
b) no segment of the plurality of segments that form the polyline intersects a point of the outer edge of the primary area between the first and second vertices of the segment;
c) no segment of the polyline intersects a different segment of the same polyline;
d) a vertex of a first segment of the polyline does not intersect a second segment to form a closed geometric figure, and
e) the ends of the polyline do not join together to form a closed polygon.

The stored polyline divides the primary terrestrial area into two secondary areas, which together cover the entire primary terrestrial area. In certain embodiments, the method further comprises repeating the steps from (i) to (v) so as to divide one of the secondary areas into two sub-areas by an additional polyline, the primary terrestrial area being thus divided into three secondary areas, the union of the three secondary areas covering the primary terrestrial area. Preferably, the method comprises repeating the steps from (i) to (v) to divide the primary terrestrial area into the plurality of elemental areas.

Preferably, associating each elemental area with at least one numerical time interval comprises associating each elemental area with a plurality of adjacent sequential numerical time intervals, each interval of the plurality being associated with a respective historical layer and the plurality of the numerical time intervals forms the macro-numerical interval indicative of the macro-historical period.

Further features and advantages of the method of the present invention will result from the following description of one preferred exemplary embodiment thereof, which is given by way of illustration and without limitation with reference to the accompanying figures, in which:

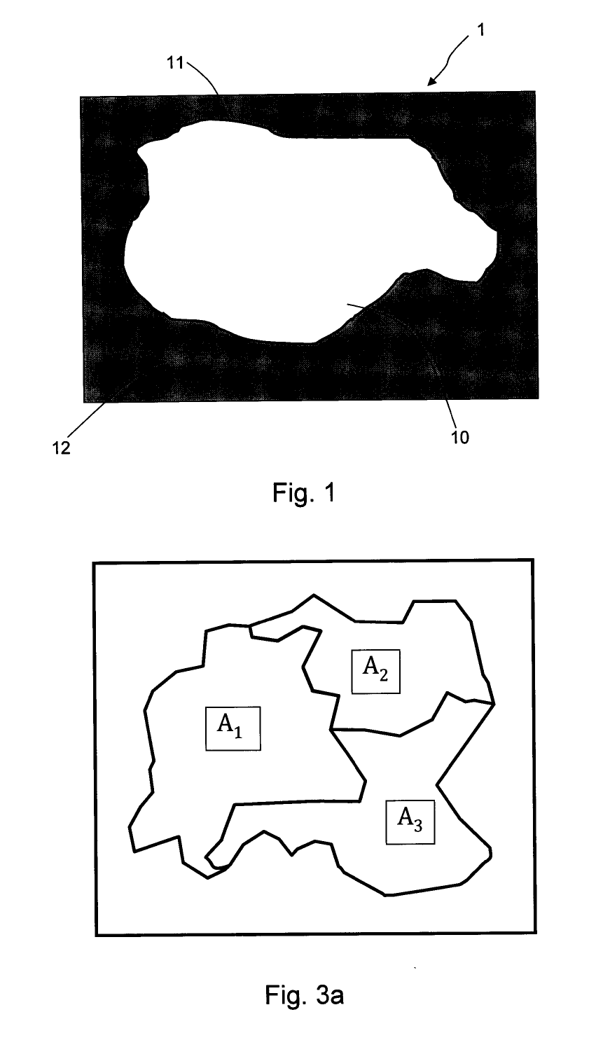

FIG. 1 is a schematic view of an example of a displayed primary image.

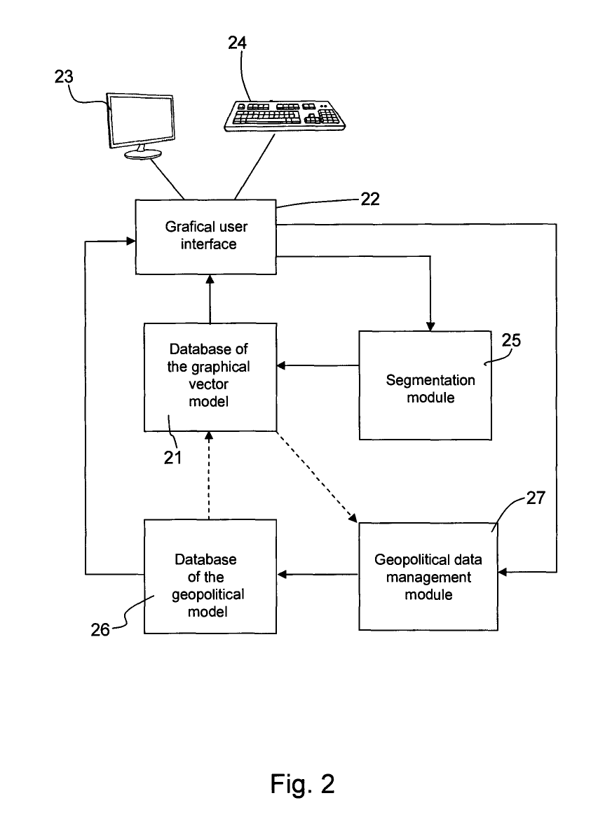

FIG. 2 is a diagram of a system for generating a historical-geographic representation of a geographical area of interest, i.e. a primary area, according to an embodiment of the present invention.

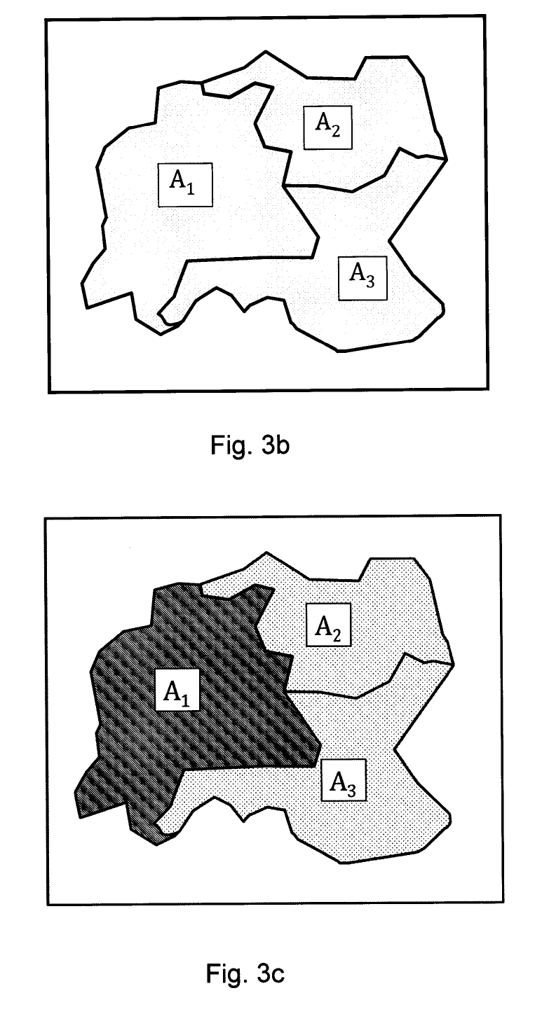

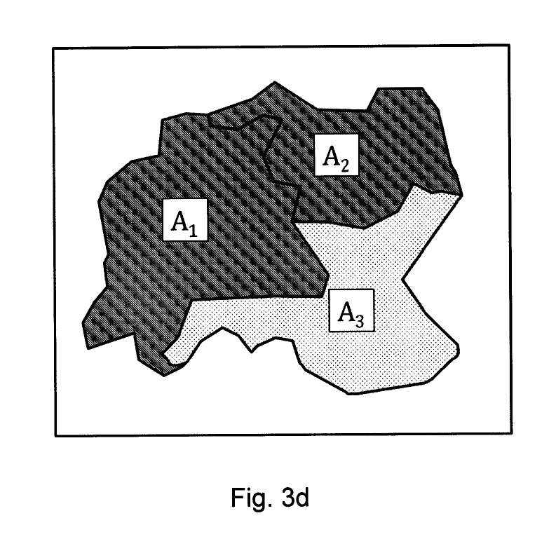

FIG. 3a schematically shows an example of division of a primary area into a plurality of elemental areas.

FIG. 3b shows a graphical representation of the area of FIG. 3a at a first historical time.

FIG. 3c shows a graphical representation of the area of FIG. 3a at a second historical time.

FIG. 3d shows a graphical representation of the area of FIG. 3a at a third historical time.

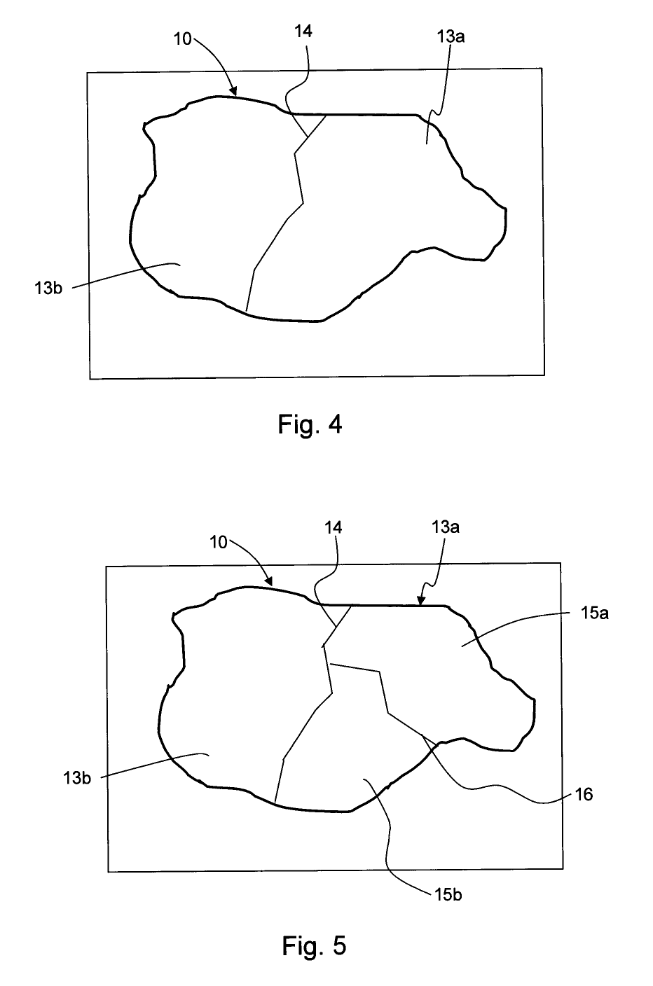

FIG. 4 schematically shows the division of a primary terrestrial area into two secondary areas by means of a polyline.

FIG. 5 schematically shows a division of a secondary terrestrial area, following the one of FIG. 4.

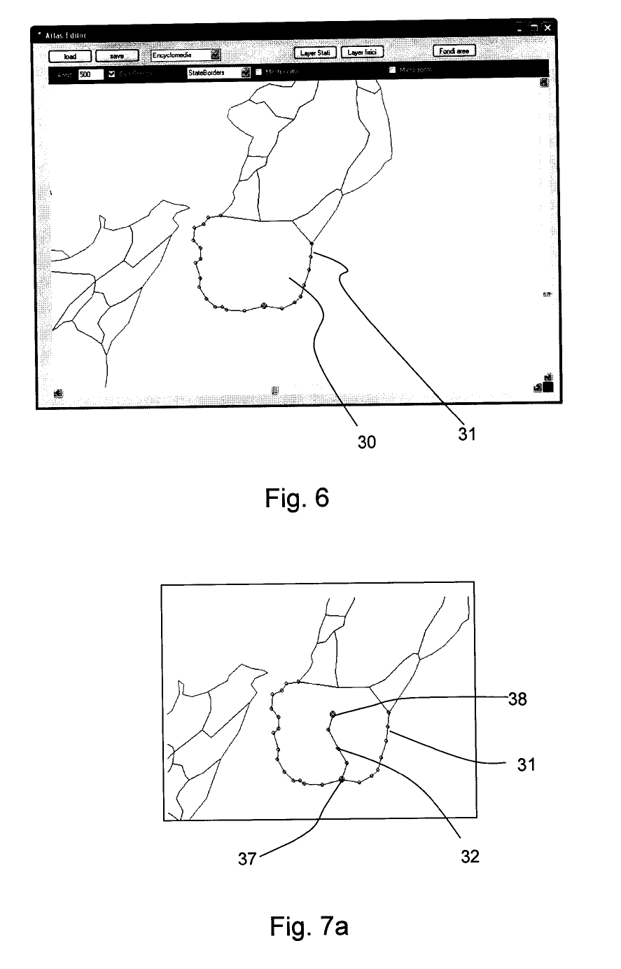

FIG. 6 shows an example of how the segmentation module input template for the segmentation module is graphically displayed on a monitor.

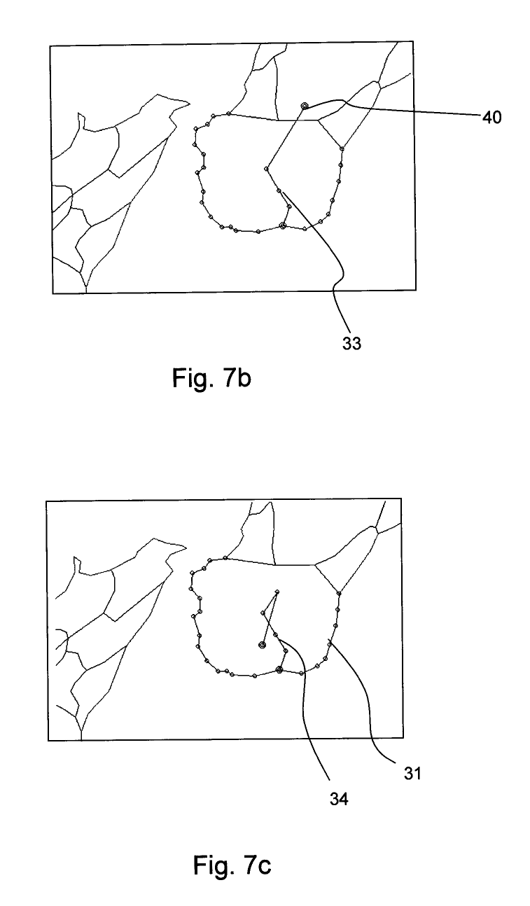

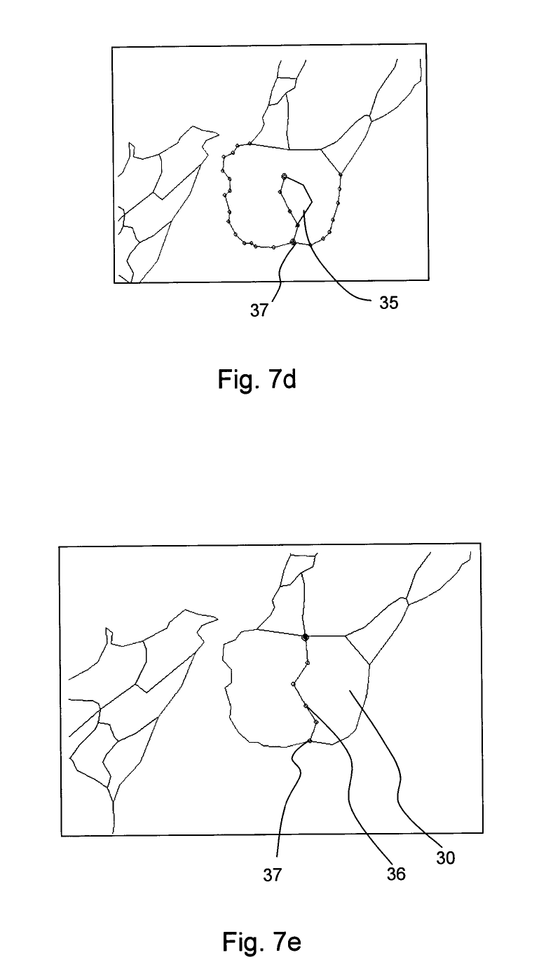

FIGS. 7a-7e show examples of tracing of a polyline for dividing the secondary area 31 of FIG. 6.

FIG. 1 schematically shows an example of a starting image 1. referred to hereafter as a primary image, which is displayed on a screen associated with a computer system. The primary image is a geographic map defined by a geographic data file in a vector format, and represented by a digital image in a vector format, which comprises a primary geographical area of interest 10 bounded by an outer edge 11, and a background area 12, external to the geographical area of interest and preferably surrounding and bordering the latter. The background area 12 defines, for example, the seas surrounding the primary area and/or the geographical regions that are not considered in the method of generation of a historical-geographic representation. In the preferred embodiments, the area of interest is associated with a 2-dimensional topographic projection of the portion of the terrestrial surface, comprising for instance the European continent.

While this is not shown in FIG. 1, the geographic data that forms the primary image is intended to include geographic information that allows the visualisation of conformations and geographic elements to a desired detail level, for example rivers, mountain chains, sites of modern cities, etc. In the vector representation, the borders, e.g. the outer edge of the primary area of interest, are defined by a series of points which are joined by straight lines to form the characteristic graphical representation. Points are coded by a pair of numbers which provide the X and Y coordinates in topographic projection systems per se known. In one embodiment, the primary image is based on a Lambert conformal conic topographic projection. Nevertheless, further two-dimensional topographic projections may be used for two-dimensional representation of the primary image, such as the transverse Mercator cylindrical projection.

In the example of FIG. 1, the primary area 10, which defines the geographical area of interest, is composed of a number of contiguous terrestrial geographical regions (i.e. not separated by background area portions, such as seas). The primary terrestrial area is indicated by the white color, whereas the background area is indicated by the grey color. It shall be noted that the area is not necessarily composed of a number of contiguous terrestrial geographical regions.

FIG. 2 is a diagram showing a system for creating a historical-geographic representation.

The graphical user interface 22 is logically connected, in the usual ways, to a screen 23 and an input unit 24, such as a keyboard and a mouse, a touchscreen of a user terminal, e.g. a PC.

The graphical user interface shows a combination of data extracted from a database of a graphical vector model 21 and from a database of a geopolitical model 26 in appropriate display modes (e.g. magnification, positioning, selective display of objects, coordinate systems, geographic projections, historical time period).

The geopolitical data model 26 is dependent on the graphical vector model 21, in that it forcibly refers to the area defined therein.

The changes and controls realized by the user on the graphical interface are interpreted by two control modules: the segmentation module 25 and the geopolitical data management module 27.

The segmentation module 25 performs actions responding to user controls concerning creation and change of points, broken lines (i.e. polylines) and of areas composing the representation. The segmentation module imposes a plurality of rules, as described below and associated with topological conditions, and ensures consistency of the graphical vector model 21, by forcing the user to fulfill the plurality of constraints defined at topological level. Accordingly, it changes the graphical vector model 21, which is made immediately visible to the user through the user interface.

The geopolitical data management module 27 executes user controls concerning data superstructures that describe the definitions of historical layers (“layers”), cities, city names and time periods of the historical-geographic representation. A historical layer identifies a geopolitical entity and is associated with a plurality of geographical names, e.g. names of cities and regions existing at the time of the geopolitical entity, and with the geographical location of such cities and regions.

The module 27 imposes the rules for definition of data structures for the geopolitical model 26 and maintains alignment with the underlying graphical vector model 21.

The segmentation module 25 is logically connected to the database of the graphical vector model 21 and the graphical user interface 22. The segmentation module is adapted to receive input graphic data associated with a segmentation of the primary area, to respond to the received graphic data by checking whether the topological condition rules are fulfilled and, if they are, to change the graphical vector model 21, which generates a division of the primary area which will be immediately visible to the user through the graphical user interface. The input graphic data is received by the segmentation module through the graphical user interface 22 connected to the input unit by which the user inputs graphic data identifying a segment, or more generally a succession of segments, i.e. a polyline. The generation of segmentation and, more generally, the process of division of the primary area will be now described in greater detail.

FIG. 3a schematically shows an example of division of a primary area into a plurality of elemental areas. In this example, the primary area is divided into three elemental areas A1, A2 and A3. Each elemental area is associated with a plurality of time intervals, each time interval be associated with a historical layer. As far as implementation is concerned, a historical layer may be identified by an ID code which, in the system of the embodiment as shown in FIG. 2, is stored in the geopolitical data management module 27. In the present example, the reference macro-historical period is an interval of years (1200, 2000) and this macro-historical period is divided, for simplicity, into three historical layers, S1, S2 and S3, which are indicated, still by way of example, as identifying the geopolitical entities Ancient Empire, Middle Kingdom and Modern State respectively (Table 1).

TABLE 1

| Historical layer | Name |
|---|---|
| S1 | Ancient Empire |
| S2 | Middle Kingdom |
| S3 | Modern State |

The elemental area A1 is associated with three time intervals, which are associated with respective historical layers (Table 2), i.e. a first time interval (1200, 1399) associated with the layer S1, a second time interval (1400, 1799) associated with the layer S2 and the third time interval (1800, 2000) associated with the layer S3.

TABLE 2

| | |
|---|---|
| Historical | Time interval |

| layer for A1 | Since | To |
|---|---|---|
| S1 | 1200 | 1399 |
| S2 | 1400 | 1799 |
| S3 | 1800 | 2000 |

Table 3 shows the time intervals associated with the historical layers for the elemental area A2, whereas Table 4 shows the time intervals for the elemental area A3. It shall be noted that, for each elemental area, the time intervals are adjacent and sequential and their sum corresponds to the macro-period P=(1200, 2000).

TABLE 3

| | |
|---|---|
| Historical | Time interval |

| layer for A2 | Since | To |
|---|---|---|
| S1 | 1200 | 1599 |
| S2 | 1600 | 2000 |

TABLE 4

| | |
|---|---|
| Historical | Time interval |

| layer for A3 | Since | To |
|---|---|---|
| S1 | 1200 | 1799 |
| S2 | 1800 | 2000 |

A query template is generated by the graphical user interface to create inputs and/or provide fields to a user who enters and/or selects the template contents, particularly to enter or select a historical time within the macro-historical period, e.g. years 1200-2000, to display the geopolitical confirmation of the primary area at such given historical time. Preferably, the template contains a data input field layout. FIG. 3b assumes that a user has selected/entered the year 1300 as a historical time in the query template of the system for creating a historical-geographic representation, by means of the input unit and through the graphical user interface. Referring to Tables 1-3, for each elemental area A1-A3, the selected year is included in the layer S1, i.e. at the selected historical time all the elemental areas are within the same geopolitical entity referred to as S1, i.e. the Ancient Empire. The graphical representation of the whole primary area will be displayed with a first color associated with S1, shown in FIG. 3b as a dotted area, namely the map is displayed as a single one-color historical layer.

FIG. 3c assumes that the user has selected, as a historical time, the year 1500. For the elemental areas A2 and A3, such historical time is included in a time range associated with the historical layer S1, whereas for the area A1, the historical time is included in a time interval associated with the historical layer S2. The graphical representation of the primary area of the selected historical time will be divided into two sub-regions, i.e. a first sub-region formed by the areas A2 and A3, which is displayed with the first color (a dotted area in the figure), and a second sub-region formed by the area A1, which is displayed with a second color associated with S2 (a grey area in the figure).

FIG. 3d assumes that the user has selected the year 1700, as a historical time for the representation of a geopolitical map. The areas A1 and A2 are associated with the layer S2, whereas the area A3 is associated with the layer S1, which is representative of the fact that the area A2 was assimilated to the Middle Kingdom (S2) which expanded at the expense of the Roman Empire (S1).

As shown in the above example, two different time intervals may be associated with the same historical layer for two different elemental areas, to indicate that the two elemental areas were included in the same geopolitical entity for different time periods. The plurality of homogeneous political regions at a given historical time are displayed on the monitor with the same color.

More generally, each historical layer, i.e. the ID code that defines it, is associated with a numerical light intensity value, such that different historical layers are associated with different numerical light intensity values. Light intensity values may be associated with respective colors according to the RGB method or with dotted or hatched patterns of the same or different colors.

Referring back to FIG. 2, the segmentation module is adapted to receive input graphic data (through the graphical user interface) identifying a polyline, to generate a digital representation of the input graphic data, to determine the polyline topology in the primary image, to check whether the polyline topology fulfills certain topological conditions and, if the check is positive, to store the polyline. The word topology is intended to indicate the spatial relationship of a graphic element (e.g. a polyline) to the other graphic elements of the image overlapped by the graphic element, such spatial relations including, for instance, connection, intersection, adjacency and inclusion.

The segmentation module, with the polyline stored therein, transmits the digital representation of the input graphic data of the polyline to the database of the graphical vector model, thereby changing the graphical vector model.

FIG. 4 schematically shows the division of a primary terrestrial area, referenced 10, into two secondary areas 13a and 13b by means of a polyline 14.

The polyline is defined by a plurality of successive segments, each segment having a vertex in common with another segment of the plurality. A segment is usually defines as a portion of a line bounded by two points.

The polyline may be manually plotted. As is known in the art, the operator may use the mouse as an input unit to select the position of the vertices of the polyline segments, on the geographic map, by means of the graphical interface. The selected vertex may be displaced, removed or further vertices may be added upstream or downstream from the selected vertex.

The segmentation module is configured to check whether the two secondary sub-areas so created cover together the entire primary area, namely the primary area contains no regions that are not included in any of the two secondary areas 13a and 13b. Such check comprises the check of whether both ends of the polyline coincide with two respective points of the outer edge of the primary geographical area. If this check has a negative result, the program rejects the polyline and may be configured to display a message on the screen, to inform the operator that the polyline cannot be stored. Preferably, both ends of the polyline coincide with the vertex of a respective segment of the polyline that forms the outer edge of the primary area, or both ends of the polyline coincide with respective vertices of the outer edge.

The segmentation module, which is implemented, for example, as an application program, is configured to check whether a polyline is plotted according to a plurality of polyline generation rules, which are indicated herein by topological conditions. If the check is positive for each of the plurality of rules, the application program is configured to accept and store the polyline and the area division generated thereby. If the check have a negative result, the program rejects the polyline and may be configured to display a message on the screen, to inform the operator that the polyline cannot be stored.

Preferably, after plotting of a polyline, and hence after reception of the input graphic data identifying a polyline, generation of a digital representation of the input image data and determination of the polyline topology in the primary image, the method comprises a step in which it checks whether the following topological conditions are fulfilled:
a) both ends of the polyline coincide with two respective points of the outer edge of the primary geographical area;
b) no segment of the polyline intersects a point of the outer edge of the primary area between the two vertices of the segment (particularly, none of the ends of the polyline is located outside the primary area);
c) no segment included in the polyline intersects a different segment included in the same polyline;
d) no portion of the polyline is closed, i.e. a vertex of a first segment of the polyline does not intersect a second segment to form a closed geometric figure;
e) the ends of the polyline do not join together to form a closed polygon.

If at least one of the conditions from a) to e) is not fulfilled, the polyline will be rejected. If all the topological conditions are fulfilled, the polyline is accepted by the system which stores it, as well as the associated division of the primary area which is graphically represented on the screen.

The checking step may be carried out by checking the topological conditions a)-e) in any sequential order.

The outer edge of the primary area is a closed outline and the vector representation of the outer edge (borders of the area of interest) is represented by a polyline composed of a plurality of successive segments. Each segment has a vertex in common with the segment that follows, and the condition a) is fulfilled if both ends of the dividing polyline coincide with respective vertices of a segment of the polyline that defines the outer edge.

After division of the primary area into two secondary areas, the above described segmentation process is repeated, using the computer, to divide at least one of the two secondary terrestrial areas into two further terrestrial areas which form together the second area obtained from the second division. FIG. 5 schematically shows the division of the primary area after the division of FIG. 4, in which the second polyline 16 creates two secondary (sub-)areas 15a and 15b which make up the secondary area 13a.

After plotting of the second polyline 16, the method moves to a checking step, in which it checks whether the topological conditions as mentioned above with reference to the first geographical division, i.e. each of the conditions from a) to e), are fulfilled. If the checking step has a positive result, the polyline is stored in the system. If the checking step has a negative result, the polyline is rejected and the step of plotting a polyline according to the received geopolitical data is repeated.

At the end of the segmentation process, the primary terrestrial area is divided into a plurality of elemental geographical surface fractions, referred to herein as elemental areas. Each elemental area is included, at each historical time within the reference macro-historical period, in a single geopolitical entity, which means that at each historical time there is a unique association of the elemental area with a historical layer.

The joining together of all the elemental areas form a geographical area corresponding to the primary area. While the example described with reference to FIGS. 3a-3d shows a division into three elemental areas only, the segmentation process may be repeated many times, to obtain a large number of divisions. For instance, a primary area corresponding to the European geographical region may be divided into 10,000 elemental areas, the number and size of the elemental areas also depending on the macro-historical period being considered and on the desired time accuracy.

Therefore, the division rules as used in the present method of creating a historical-geographic representation identify the elemental surface fractions that remain indivisible along the time axis of the historical times included in a given macro-historical period. In other words, each elemental area is historically homogeneous.

FIG. 6 shows an example of how an input template screen of the segmentation module, and particularly a portion of the primary area image corresponding to Europe, that went through a plurality of divisions, is displayed on the monitor. The illustrated portion comprises two terrestrial areas, particularly portions of two geographical regions (corresponding to a Southern portion of the Italian region of Calabria and a Northern portion of the Italian region of Sicily), which are delimited by an outer edge, bordering the sea. The segmentation method is assumed to divide a secondary area 30 defined by a polyline as its outer edge 31.

FIGS. 7a-7e show examples of plotting of a polyline for dividing the secondary area 30 of FIG. 6. FIG. 7a shows plotting of a polyline 32 whose first end coincides with a vertex 37 of the polyline 31 that defines the outer edge of the area 30. The second end 38 of the polyline 32 is located within the area 30. This polyline 32 does not fulfill the above described condition a), i.e. at least one end does not coincide with one point of the outer edge of the secondary area to be divided, and hence is rejected by the system.

FIG. 7b shows a polyline 33 that does not fulfill the topological condition b), i.e. one of the ends of the polyline, referenced 40, is located outside the area 30, such that a segment of the polyline 33 intersects the outer edge 31.

In FIG. 7c, the polyline 34 does not fulfill the condition c), i.e. a first segment within the polyline intersects a second segment within the same polyline.

In FIG. 7d, the polyline 35 does not fulfill the condition d), i.e. a vertex of a first segment of the polyline intersects a second segment not following the first segment, to form a closed polygon (“island”).

The condition e) (not shown) is not fulfilled if the vertex of a segment of the polyline coincides with the vertex of a non-consecutive segment and corresponding to the end (37 in FIG. 7d) of the same polyline, to form a closed polygon which touches the outer edge 31 at a single point. The condition e) is also not fulfilled if the polyline forms an “island” within the area 30.

In FIG. 7e, the polyline 36 fulfills the topological condition a), and the conditions from b) to e) are also fulfilled. Therefore, the polyline is accepted by the system and the division of the area 30 is stored.

The above described process of segmentation of a primary area allows division into elemental areas included, at each historical time, in a single geopolitical entity, i.e. a single historical layer.

Those skilled in the art will obviously appreciate that a number of changes and variants may be made to what has been described hereinbefore, without departure from the scope of the invention, as defined in the following claims.

1. A method of generating a historical-geographic representation from a geographic map, which comprises:
graphically rendering a geographic map file on a screen, by means of a computer, as a vector image comprising a primary terrestrial area;
dividing, by using the computer, the primary terrestrial area into a plurality of adjacent, non-overlapping elemental areas, the joining together of the elemental areas covering the entire primary area;
associating, by means of the computer, each elemental area with at least one numerical time interval, indicative of a historical interval included in a macro-numerical interval indicative of a macro-historical period, the numerical interval being associated with a historical layer, indicative of a geopolitical entity;
receiving, in the computer, time data indicative of a historical time included in said macro-historical period;
selecting, by means of the computer, a numerical time interval for each elemental area, said interval including the received time data, and extracting the historical layer associated with the selected numerical time interval;
graphically rendering, by means of the computer, the primary terrestrial area on the monitor, by associating a given numerical light intensity value with each historical layer, such that different historical layers are associated with different numerical light intensity values and the elemental areas associated with the same historical layer are graphically represented with the same light intensity value.

2. The method as claimed in claim 1, wherein the primary terrestrial area has an outer edge consisting of a closed outline, and dividing the primary terrestrial area into a plurality of elemental areas comprises:
(i) receiving, in a computer, graphical input data, identifying a polyline composed of a plurality of successive segments, and having first and second ends;
(ii) generating a digital representation of the graphical input data;
(iii) determining the topology of the polyline in the primary image;
(iv) checking whether the topology of the polyline fulfills a plurality of topological conditions, and
(v) if the check is positive, storing the polyline.

3. The method as claimed in claim 2, wherein step (v) further comprises:
if the check is negative, rejecting the polyline and repeating the steps from (i) to (iv).

4. The method as claimed in claim 2, wherein each segment of the plurality of segments that forms the polyline has first and second vertices and the step (iv) comprises checking whether the following topological are fulfilled:
a) both ends of the polyline coincide with two respective points of the outer edge of the primary geographical area;
b) no segment of the plurality of segments that form the polyline intersects a point of the outer edge of the primary area between the first and second vertices of the segment;
c) no segment of the polyline intersects a different segment of the same polyline;
d) a vertex of a first segment of the polyline does not intersect a second segment to form a closed geometric figure, and
e) the ends of the polyline do not join together to form a closed polygon.

5. The method as claimed in claim 2, which further comprises repeating the steps from (i) to (v), such that a plurality of polylines can be stored, to divide the primary terrestrial area into a plurality of elemental areas, the number being more than two.

6. The method as claimed in claim 2, wherein the stored polyline divides the primary terrestrial area into two secondary areas, which cover together the primary terrestrial area, the method further comprising repeating the steps from (i) to (v), such that one of the two secondary areas are divided into two sub-areas by an additional polyline, the primary terrestrial area being thus divided into three secondary areas, the joining together of said areas covering the primary terrestrial area.

7. The method as claimed in claim 2, which comprises repeating the steps from (i) to (v) to divide the primary terrestrial area into the plurality of elemental areas.

8. The method as claimed in claim 1, wherein associating each elemental area with at least one numerical time interval comprises associating each elemental area with a plurality of adjacent sequential numerical time intervals, each interval of the plurality being associated with a respective historical layer and the plurality of the numerical time intervals forms the macro-numerical interval indicative of the macro-historical period.
